(19) United States
(12) Patent Application Publication
(10) Pub. No.: US 2019/0075720 A1
(43) Pub. Date: Mar. 14, 2019

(54) METHOD FOR TRANSVERSE DISPLACEMENT OF A MOWER OF AN AGRICULTURAL VEHICLE

(71) Applicant: John Deere & Company, Moline, IL (US)

(72) Inventor: Manuel Billich, Dischingen (DE)

(21) Appl. No.: 16/108,238

(22) Filed: Aug. 22, 2018

(30) Foreign Application Priority Data
Sep. 13, 2017 (DE) 102017216196.5

(51) Int. Cl. A01D 34/00

(52) U.S. Cl. CPC A01D 34/006

(57) ABSTRACT

A method is provided for transverse displacement of a front mower or a rear mower of an agricultural vehicle along a transverse direction running transversely to a longitudinal axis of the vehicle. The method includes defining the transverse displacement as a function of a determined steering angle of the vehicle. During cornering of the vehicle, the method also includes generating an overlap between a mowing area of the front mower and a mowing area of the rear mower along the transverse direction.

### RELATED APPLICATIONS

This application claims priority to German Patent Application Ser. No. 102017216196.5, filed Sep. 13, 2017, the disclosure of which is hereby incorporated by reference in its entirety.

### FIELD OF THE DISCLOSURE

The present disclosure relates to a method for transverse displacement of a front mower and/or at least one rear mower of an agricultural vehicle.

### BACKGROUND

In order to ensure mowing of the crop over the entire working width of an agricultural vehicle, a front mower and a rear mower are matched in such a manner that a slight overlap of the mowed areas of the front and the rear mowers is created during straight-ahead travel. When cornering, however, this overlap often is not sufficient to prevent unmowed areas.

Thus, there is a need for a method with which unmowed areas between the front and the rear mowers can be avoided in a simple manner, even when the agricultural vehicle is cornering.

### SUMMARY

In a first embodiment of the present disclosure, a method is provided for enabling a transverse displacement of a front mower or a rear mower of an agricultural vehicle, e.g., a tractor. This transverse displacement takes place along a transverse direction running transversely to a longitudinal axis of the vehicle. The transverse displacement is dimensioned, depending on a determined steering angle of the vehicle, in such a manner that an overlap between a mowed area of the front mower and a mowed area of a rear mower corresponding to the front mower, is generated along the transverse direction when the vehicle is cornering.

This method enables an automated transverse displacement of a front or rear mower along the transverse direction for a desired overlap of the mowed areas produced at the front end and the rear end. In this way, the driver of the vehicle is unburdened, because it is no longer necessary to carry out a manual transverse displacement. Unmowed areas due to possible incorrect operation by the driver are excluded within the technically possible transverse displacement range. The work quality of the mowing process is improved and the output in terms of area mowed is increased.

The method can be performed by means of a control unit for controlling the transverse displacement. The control function can be integrated into an existing track guidance system of the vehicle, for example.

The above-mentioned steering angle can be acquired metrologically, for example. In vehicles having a track guidance system, the respective value of the steering angle can be provided without additional technical effort.

If the driver wishes to drive on a curve that would lead to unmowed areas based on the determined steering angle and a technically limited transverse displacement range, corresponding information is provided to the driver (e.g., visually or acoustically).

The transverse displacement is calculated as a function of at least one of the following variables:
a wheelbase 1 of the vehicle,
a front longitudinal distance along the longitudinal axis of the vehicle between a front axle of the vehicle and a front mower or the cutting area thereof,
a rear longitudinal distance along the longitudinal axis of the vehicle between a rear axle of the vehicle and a rear mower or the cutting area thereof,
a mowing width of the front mower along the transverse direction,
a distance along the transverse direction between a first rear mower and a second rear mower, and
a predetermined overlap between the front mower and the rear mower along the transverse direction.

The values of the above-mentioned variables for performing the method can advantageously be provided with little or no additional technical effort. Thus, the wheelbase of the vehicle as the distance between a front axle and a rear axle of the vehicle is unambiguously known. The front longitudinal distance and the rear longitudinal distance can be communicated by means of a user input to the control unit or a system for controlling the transverse displacement. The distance between two rear mowers relates to a distance in the transverse direction between the cutting edges of these rear mowers or their mower bars facing the vehicle's longitudinal axis in a standard starting position without transverse displacement.

The above-mentioned distance of the cutting edges of two mowers from one another, and the mowing width of the front mower can be determined easily in technical terms and can likewise be communicated to the control unit or the control system via a user input. Depending on the application case, the predetermined overlap relates to the interior curve side or the exterior curve side when cornering. This overlap can be specified as a fixed value of the control unit or control system, or can alternatively be defined variably by means of a user input.

In one embodiment, the transverse displacement is limited by at least one limit value. In particular, the transverse displacement along the transverse direction is limited with two opposing limit values. The at least one limit value supports a defined mode of operation of the mowers involved for the desired overlap of the mowing areas. The at least one limit value is defined in one embodiment by a maximum or minimum technically possible or meaningful transverse displacement of the respective mower. Alternatively, a limit value can be specified variably by a corresponding user input.

A mower (e.g., a front mower or rear mower) that is displaceable in the transverse direction has a suitable actuator for the transverse displacement. Therefore the control unit or the control system merely has to trigger the actuator in order to control a given transverse displacement and thus achieve the desired overlap. In particular, an actuator that is routinely installed in a conventional mower is used, without additional technical expense. Thus, a conventional mower can be supplemented with a corresponding control or triggering of the actuator in order to carry out the method in a technically simple manner.

The actuator is designed as a hydraulic cylinder in one embodiment. A working length of the hydraulic cylinder can be controlled by adjusting a length change in order to achieve the desired overlap. A directional control valve is provided for this controlling of the working length of the hydraulic cylinder. The directional control valve is a 4/3 way valve, for example. If the function for performing the method is integrated into the vehicle, a valve installed therein can be used as the directional control valve. Alternatively, the function for carrying out the method, together with the directional control valve, can be installed in the respective mower (front or rear mower).

Other embodiments of the actuator are conceivable. For example, the actuator can have a toothed rack which is driven by an electric motor.

Depending on the technical design, the operation of the actuator and the length change or longitudinal movement thereof can imply an identical transverse displacement of the mower or can correspond to a different transverse displacement length according to a transmission ratio. The necessary transverse displacement for a detected vehicle steering angle is determined and then a corresponding target movement, length change or the like of the actuator is calculated as a function of the transmission ratio.

A rear mower is provided on each side of a vehicle longitudinal axis in the rear area of the vehicle. These mowers can each be displaced in the transverse direction. More particularly, these mowers can be displaced independently of one another. In this way, an adaptation of the working width for the mowing process can be achieved in a simple manner. This can be used to support an optimal ratio of a cutting output per area of the mowing process and an overlap between front and rear mowing areas.

The method is used for a mowing process, i.e., for a front and a rear mower. In additional applications, the method for achieving a desired transverse displacement and overlap can also be applied to other implements of an agricultural vehicle, if they have a combination of a front implement and a rear implement (for example, a mulcher combination).

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 shows a schematic plan view of an agricultural vehicle with an indicated transverse displacement of a front mower while cornering,

FIG. 2 shows a schematic representation of a valve unit for a transverse displacement of the front mower according to FIG. 1,

FIG. 3 shows a schematic plan view of an agricultural vehicle with an indicated transverse displacement of a rear mower while cornering, and

FIG. 4 shows a schematic representation of a valve unit for a transverse displacement of the two rear mowers according to FIG. 3.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

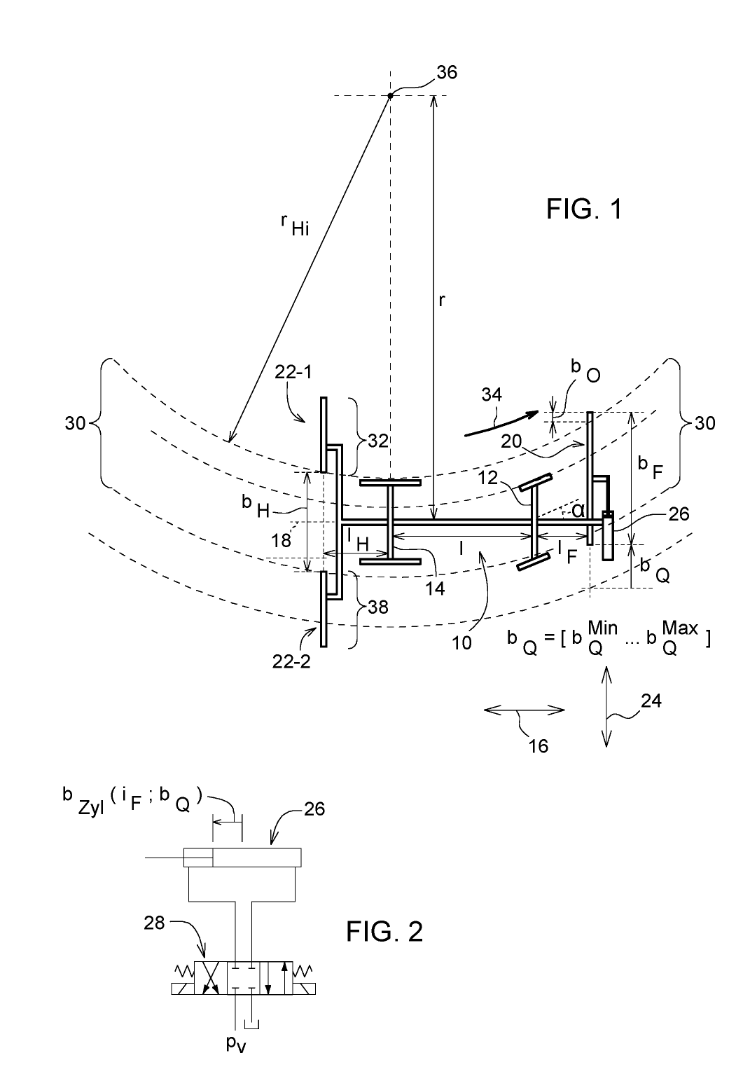

FIG. 1 schematically shows an indication of an agricultural vehicle 10 in the form of a tractor having a front axle 12 and a rear axle 14. The distance between the two axles 12, 14 constitutes a wheelbase 1. The vehicle 10 has a vehicle longitudinal axis 18 arranged in the longitudinal direction 16. The vehicle 10 supports a front mower 20 which is arranged a front longitudinal distance l_{F} from the front axle 12 along the longitudinal axis 18. A mowing width of the front mower 20 or the mowing bar thereof in the transverse direction 24 is designated b_{F}. Two mowers 22-1, 22-2 are arranged in the rear area of the vehicle 10. A rear longitudinal distance l_{H} in the longitudinal direction 16 is defined between the mowers and the rear axle 14. Along a transverse direction 24 arranged transversely to the longitudinal direction 16, the cutting edge of the rear mower 22-1 is a distance b_{H} from the opposing cutting edge of the second mower 22-2. This corresponds to the standard starting position of the rear mower 22-1, 22-2 without transverse displacement along the transverse direction 24.

FIG. 1 shows an actuator in the form of a hydraulic cylinder 26 as an integrated component of the front mower 20. Depending on the activation, the actuator or hydraulic cylinder 26 effects a transverse displacement of the front mower 20 along the transverse direction 24. A specific length change b_{Zy1} of a working length of the hydraulic cylinder 26, as shown in FIG. 2, effects a calculated necessary transverse displacement b_{Q} of the front mower 20. The specific change of length b_{Zy1} is dependent on a transmission ratio i_{F}=b_{Q}/b_{Zy1} between the transverse displacement b_{Q} and the change of length b_{Zy1}. The change of length b_{Zy1} calculated to be necessary in each case is achieved by appropriate control of the hydraulic cylinders 26 by a valve unit 28. The valve unit 28 controls a supply pressure p_{V} for the hydraulic cylinder 26. The valve unit 28 in FIG. 2 is designed as a 4/3 way valve.

In the embodiment in FIG. 1, a transverse displacement b_{Q} of the front mower 20 is implemented in order to generate a desired or specified overlap b_{O}. This overlap b_{O} is formed along the transverse direction 24 between a mowing area 30 of the front mower 20 and a mowing area 32 of the rear mower 22-1.

To generate the overlap b_{O}, the necessary transverse displacement b_{Q} of the front mower 20 is first calculated as a function of a steering angle α of the vehicle 10. This transverse displacement b_{Q} is then converted into a corresponding change of length b_{Zy1} of the hydraulic cylinder 26 as a function of the transmission ratio i_{F}.

For the calculation of the necessary transverse displacement b_{Q} for the desired or specified overlap b_{O}, it is assumed that both the front mower 20 and the rear mowers 22-1, 22-2 are in a standard starting position symmetrically to the vehicle longitudinal axis 18 and without transverse displacement along the transverse direction 24. The subsequently explained calculation of the transverse displacement b_{Q} of the front mower 20 according to FIG. 1 can also be used correspondingly for asymmetrically arranged mowers. For the calculation in the embodiment according to FIG. 1, the following boundary conditions will be defined.

For a transverse displacement b_{Q}=0, the front mower 20 is arranged symmetrically to the longitudinal axis 18 and the condition α=0 applies for the steering angle α, i.e. the vehicle 10 is in straight-ahead travel along the longitudinal direction 16.

Here, b_{Q}>0 signifies a transverse displacement of the front mower 20 to the left relative to a forward travel of the vehicle 10. This corresponds to the case illustrated in FIG. 1 with a leftward curve along the travel direction 34. The steering angle α is defined by the condition α>0.

Moreover, b_{Q}<0 signifies a transverse displacement of the front mower 20 to the right relative to a forward travel of the vehicle 10. The steering angle α is defined by the condition α<0.

From these definitions, a maximum limit value b_{Q}^{Max} for the technically possible displacement range of the front mower 20 along the transverse direction 24 results for b_{Q}>0 and a minimum limit value b_{Q}^{Min} results if b_{Q}<0, even if a larger (positive) or smaller (negative) value for the transverse displacement b_{Q} is calculated according to the method.

For α>0 and b_{Q}≤b_{Q}^{Max}:

b_{Q}=sin(−arccos((l+l_{F})/r_{Hi}))r_{Hi}+r+b_{O}−b_{F}/2. (1)

For α<0 and b_{Q}≥b_{Q}^{Min}:

b_{Q}=−sin(−arccos((l+l_{F})/r_{Hi}))r_{Hi}−r−b_{O}+b_{F}/2. (2)

The two curve radii r and r_{Hi} are defined relative to a curve center point 36 in FIG. 1 as follows:

r=l/|tan(α)|, (3)

r_{Hi}=(l_{H}²+(b_{H}/2−r)²)^{1/2}. (4)

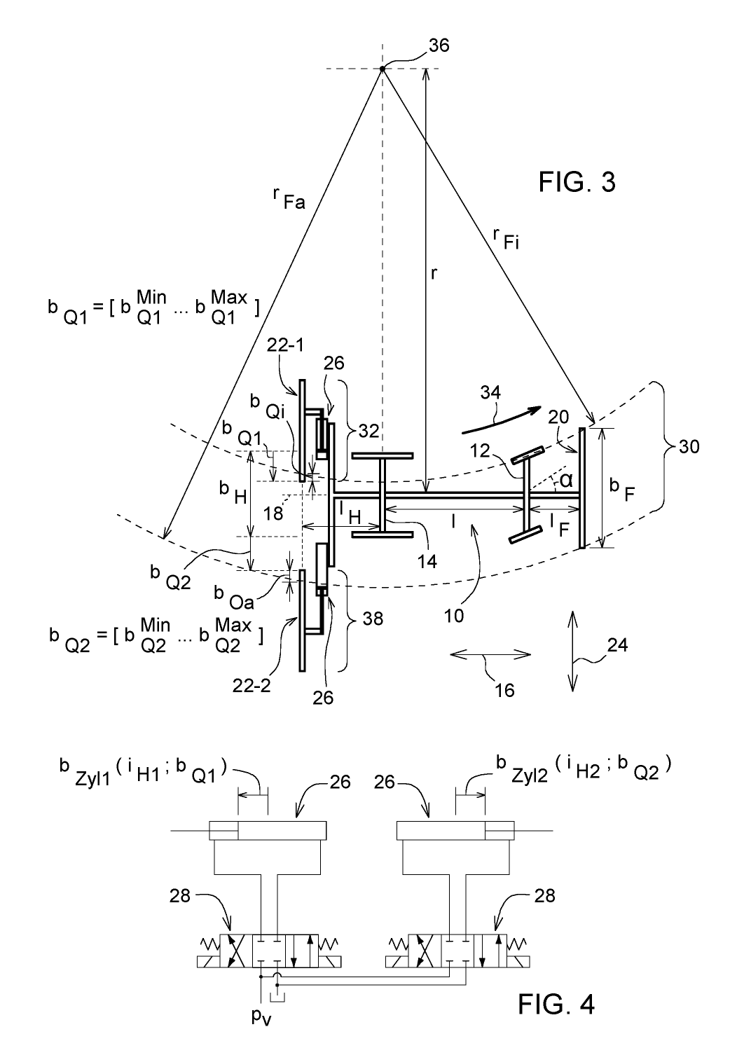

In FIG. 3, the front mower 20 is in a standard symmetrical starting position relative to the longitudinal axis 18, while the two rear mowers 22-1 and 22-2 will be displaced along the transverse direction 24. The two rear mowers 22-1 and 22-2 each have an actuator in the form of a hydraulic cylinder 26. Depending on the activation, the actuator or hydraulic cylinder 26 effects a transverse displacement of the respective rear mower 22-1, 22-2 along the transverse direction 24. As illustrated in FIG. 4, the specific change of length b_{Zy11}, b_{Zy12} of a working length of the respective hydraulic cylinder 26 effects a calculated necessary transverse displacement b_{Q1}, b_{Q2}, respectively, of the rear mower 22-1, 22-2. The specific change of length b_{Zy11}, b_{Zy12}, respectively, is dependent on a transmission ratio i_{H1}=b_{Q1}/b_{Zy11}, i_{H2}=b_{Q2}/b_{Zy12} between the respective transverse displacement b_{Q1}, b_{Q2} and the change of length b_{Zy11}, b_{Zy12}. The change of length b_{Zy11}, b_{Zy12} calculated to be necessary in each case is achieved by appropriate control of the respective hydraulic cylinder 26 by a valve unit 28. The valve unit 28 controls a supply pressure p_{V} for the hydraulic cylinder 26. The valve units 28 in FIG. 2 are each designed as a 4/3 way valve.

In the embodiment shown in FIG. 3, transverse displacements b_{Q1}, b_{Q2}, respectively, of the rear mowers 22-1, 22-2 are produced in order to generate a desired or specified overlap b_{Oi}, b_{Oa}. The overlap b_{Oi} is formed along the transverse direction 24 between the mowing area 30 of the front mower 20 and the mowing area 32 of the rear mower 22-1, while the overlap b_{Oa} is formed along the transverse direction 24 between the mowing area 30 of the front mower 20 and a mowing area 38 of the rear mower 22-2.

To generate the respective overlap b_{Oi}, b_{Oa}, the necessary transverse displacement b_{Q1}, b_{Q2} of the rear mower 22-1, 22-2 is first calculated as a function of a steering angle α of the vehicle 10. These transverse displacements are then converted as a function of the respective transmission ratio i_{H1}, i_{H2} into the corresponding change of length b_{Zy11}, b_{Zy12} of the respective hydraulic cylinder 26.

In the calculation of the necessary transverse displacement for the desired or specified overlap b_{Oi}, b_{Oa}, it is again assumed that both the front mower 20 and the rear mowers 22-1, 22-2 are in a standard starting position symmetrically to the vehicle longitudinal axis 18 and without transverse displacement along the transverse direction 24. The subsequently explained calculation of the transverse displacements b_{Q1}, b_{Q2} can also be used correspondingly for asymmetrically arranged mowers. For the calculation in the embodiment according to FIG. 3, the following boundary conditions will be defined.

At a steering angle α=0, the vehicle 10 is traveling straight-ahead along the longitudinal direction 16 and the transverse displacements are b_{Q1}=0, b_{Q2}=0. A steering angle α>0 signifies a leftward curve along the travel direction 34 in FIG. 3. α<0 accordingly signifies a rightward curve along the travel direction 34.

Here, b_{Q1}>0, b_{Q2}>0 respectively signify a transverse displacement of the respective rear mower 22-1, 22-2 toward the longitudinal axis 18. Further, b_{Q1}<0, b_{Q2}<0 respectively signify a transverse displacement of the respective rear mower 22-1, 22-2 away from the longitudinal axis 18. The maximum technically possible displacement range of the respective rear mower 22-1, 22-2 along the transverse direction 24 is limited by a respective maximum limit value b_{Q1}^{Max}, b_{Q2}^{Max} for b_{Q1}>0, b_{Q2}>0 and a minimum limit value b_{Q1}^{Min}, b_{Q2}^{Min} for b_{Q1}<0, b_{Q2}<0, even if a larger (positive) or smaller (negative) value for the respective transverse displacement b_{Q1}, b_{Q2} is calculated according to the method.

In addition to the above-mentioned boundary conditions, the following holds for the necessary transverse displacement b_{Q1} of the rear mower 22-1 for α<0 and b_{Q1}<b_{Q1}^{Max}:

b_{Q1}=−sin(−arccos(−l_{H}/r_{Fa}))r_{Fa}−r−b_{Oa}+b_{H}/2, (5)

and for α>0 and b_{Q1}≥b_{Q1}^{Min}:

b_{Q1}=sin(−arccos(−l_{H}/r_{Fi}))r_{Fi}+r−b_{Oi}−b_{H}/2. (6)

The curve radii r, r_{Fi} and r_{Fa} relative to the curve center point 36 in FIG. 3 are defined as follows:

r is defined by equation (3),

r_{Fi}=((l+l_{F})²+(b_{F}/2−r)²)^{1/2}, (7)

r_{Fa}=((l+l_{F})²+(b_{F}/2−r)²)^{1/2}. (8)

For the necessary transverse displacement b_{Q2} of the rear mower 22-2 the following holds with α>0 and b_{Q2}≤b_{Q2}^{Max}:

b_{Q2}=−sin(−arccos(−l_{H}/r_{Fa}))r_{Fa}−r−b_{Oa}+b_{H}/2, (9)

and with α<0 and b_{Q2}≥b_{Q2}^{Min}:

b_{Q2}=sin(−arccos(−l_{H}/r_{Fi}))r_{Fi}+r−b_{Oi}−b_{H}/2. (10)

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for transverse displacement of a front mower or at least one rear mower of an agricultural vehicle along a transverse direction running transversely to a longitudinal axis of the vehicle, the method comprising:
defining the transverse displacement as a function of a determined steering angle of the vehicle; and
during cornering of the vehicle, generating an overlap between a mowing area of the front mower and a mowing area of the rear mower along the transverse direction.

2. The method of claim 1, wherein the transverse displacement is determined as a function of at least one of a wheelbase of the vehicle, a front longitudinal distance along the longitudinal axis between a front axle of the vehicle and a front mower, a rear longitudinal distance along the longitudinal axis between a rear axle of the vehicle and a rear mower, a mowing width of the front mower along the transverse direction, a distance along the transverse direction between a first rear mower and a second rear mower, a predetermined overlap between the front mower and the rear mower along the transverse direction.

3. The method of claim 1, further comprising limiting the transverse displacement by a limit value.

4. The method of claim 1, further comprising providing the front mower or the rear mower with an actuator for transverse displacement.

5. The method of claim 1, further comprising providing one rear mower on each side of the vehicle longitudinal axis in the transverse direction.

6. The method of claim 1, further comprising defining the transverse displacement based on at least one of a wheelbase of the vehicle.

7. The method of claim 1, further comprising defining the transverse displacement based on a front longitudinal distance along the longitudinal axis between a front axle of the vehicle and a front mower.

8. The method of claim 1, further comprising defining the transverse displacement based on a rear longitudinal distance along the longitudinal axis between a rear axle of the vehicle and a rear mower.

9. The method of claim 1, further comprising defining the transverse displacement based on a mowing width of the front mower along the transverse direction.

10. The method of claim 1, further comprising defining the transverse displacement based on a distance along the transverse direction between a first rear mower and a second rear mower.

11. The method of claim 1, further comprising defining the transverse displacement based on a predetermined overlap between the front mower and the rear mower along the transverse direction.

12. A method for transverse displacement of a front mower or at least one rear mower of an agricultural vehicle along a transverse direction running transversely to a longitudinal axis of the vehicle, the method comprising:
defining the transverse displacement as a function of a determined steering angle of the vehicle;
during cornering of the vehicle, generating an overlap between a mowing area of the front mower and a mowing area of the rear mower along the transverse direction; and
limiting the transverse displacement by a limit value.

13. The method of claim 12, wherein the transverse displacement is determined as a function of at least one of a wheelbase of the vehicle, a front longitudinal distance along the longitudinal axis between a front axle of the vehicle and a front mower, a rear longitudinal distance along the longitudinal axis between a rear axle of the vehicle and a rear mower, a mowing width of the front mower along the transverse direction, a distance along the transverse direction between a first rear mower and a second rear mower, a predetermined overlap between the front mower and the rear mower along the transverse direction.

14. The method of claim 12, further comprising providing the front mower or the rear mower with an actuator for transverse displacement.

15. The method of claim 12, further comprising providing one rear mower on each side of the vehicle longitudinal axis in the transverse direction.

16. A method for transverse displacement of a front mower or a rear mower of an agricultural vehicle along a transverse direction running transversely to a longitudinal axis of the vehicle, the method comprising:
providing the front mower or the rear mower with an actuator for transverse displacement;
defining the transverse displacement as a function of a determined steering angle of the vehicle; and
during cornering of the vehicle, generating an overlap between a mowing area of the front mower and a mowing area of the rear mower along the transverse direction.

17. The method of claim 16, wherein the transverse displacement is determined as a function of at least one of a wheelbase of the vehicle, a front longitudinal distance along the longitudinal axis between a front axle of the vehicle and a front mower, a rear longitudinal distance along the longitudinal axis between a rear axle of the vehicle and a rear mower, a mowing width of the front mower along the transverse direction, a distance along the transverse direction between a first rear mower and a second rear mower, a predetermined overlap between the front mower and the rear mower along the transverse direction.

18. The method of claim 16, further comprising limiting the transverse displacement by a limit value.

19. The method of claim 16, further comprising providing one rear mower on each side of the vehicle longitudinal axis in the transverse direction.

20. The method of claim 16, wherein the transverse displacement is determined as a function of a wheelbase of the vehicle, a front longitudinal distance along the longitudinal axis between a front axle of the vehicle and a front mower, a rear longitudinal distance along the longitudinal axis between a rear axle of the vehicle and a rear mower, a mowing width of the front mower along the transverse direction, a distance along the transverse direction between a first rear mower and a second rear mower, and a predetermined overlap between the front mower and the rear mower along the transverse direction.
